(19) United States
(12) Patent Application Publication
(10) Pub. No.: US 2025/0139351 A1
(43) Pub. Date: May 1, 2025

(54) SCREEN-AWARENESS ADJUST VISUALIZATION

(71) Applicant: META PLATFORMS, INC., Menlo Park, CA (US)

(72) Inventor: Ziliu Li, Redmond, WA (US)

(21) Appl. No.: 18/823,237

(22) Filed: Sep. 3, 2024

Related U.S. Application Data
(60) Provisional application No. 63/595,154, filed on Nov. 1, 2023.

(51) Int. Cl. G06F 40/106; G06F 40/166

(52) U.S. Cl. CPC G06F 40/106; G06F 40/166

(57) ABSTRACT

A system and method for providing screen-aware adjustment visualizations associated with displays are provided. The system may facilitate training a large language model to generate a plurality of types of content to improve text content associated with at least one document. The system may further facilitate extracting and reconstructing items of content from a portable document format document. The system may further maintain a semantic order of elements associated with the content. The system may further dynamically organize the content within a display of a device.

### CROSS-REFERENCE TO RELATED APPLICATIONS

This application claims the benefit of U.S. Provisional Application No. 63/595,154 filed Nov. 1, 2023, the entire content of which is incorporated herein by reference.

### TECHNICAL FIELD

Examples of the present disclosure may relate generally to methods, apparatuses and computer program products for providing screen-aware adjustment visualizations associated with displays.

### BACKGROUND

Portable Document Format (PDF) is a file format that presents text, images, and other data in a reliable, interactive, and editable form. PDF is widely adopted and used (say share content in community as an attachment), with several advantages: 1) Cross-platform compatibility: PDF files may be viewed and printed on any device and any operating system, including computers, smartphones, and tablets. 2) Easy to share: PDF files may be easily shared through email or cloud storage services, making them a convenient way to distribute documents.

However, PDF may come with several limitations, especially the challenge of reading PDF in smaller screens as it often may be designed to mimic printed documents. The challenge comes with several characteristics of PDF, which may include the following as examples.

A lot of variant type information, including charts, diagrams, and other graphical elements.

Different font size (small fonts) or fine details that may be hard to discern on a small screen.

Some existing solutions lack tooling and may be limited by allowing manually zooming in or scrolling around to access information. (See e.g., FIGS. 4Ai, 4Aii, 4Aiii, 4Aiv and 4B).

There may be disadvantages to these existing solutions.

For instance, manually zooming in or scrolling around to access information may provide a bad experience (e.g., negative/undesirable user experience). The operation may not be user-friendly and may be easy to lose information.

Some existing solutions may provide a reflow feature in a PDF reader. For example, some PDF reader tools may provide a reflow feature to adjust the layout of a PDF. (See e.g., FIG. 5).

Reflow typically operates by converting the original PDF document into a simplified version with a linear reading flow, removing columns, tables, and other non-linear elements. This may allow the text to adjust to the screen size (e.g., of a display device) thus, making it easier to read without having to zoom in or scroll around.

There may be drawbacks to this reflow feature approach.

For example, there may be limited element support and the reflow approach may mainly work on text.

The reflow feature may cause a PDF document to not be well organized. For instance, the text extracted and displayed may be in the wrong order, and may lead to information loss or misleading information/content.

The reflow feature may not support scan types of PDF.

As such, it may be beneficial to provide an efficient and reliable mechanism to enable screen-aware adjustment visualizations of PDFs associated with displays.

### BRIEF SUMMARY

A solution of the examples of the present disclosure proposes an innovative approach to resolve the challenge for PDFs in different sizes of screen devices.

In one example of the present disclosure, a method is provided. The method may include training a large language model (LLM) to generate a plurality of types of content to improve text content associated with at least one document. The method may further include extracting and reconstructing items of content from a portable document format document, and maintaining a semantic order of elements associated with the content. The method may further include organizing the content within a display of a device dynamically.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

A summary, as well as the following detailed description, is further understood when read in conjunction with the appended drawings. For the purpose of illustrating the disclosed subject matter, there are shown in the drawings exemplary embodiments of the disclosed subject matter; however, the disclosed subject matter is not limited to the specific methods, compositions, and devices disclosed. In addition, the drawings are not necessarily drawn to scale. In the drawings.

FIG. 1 is a diagram of an exemplary network environment in accordance with an example of the present disclosure.

FIG. 2 is a diagram of an exemplary communication device in accordance with an example of the present disclosure.

FIG. 3 is a diagram of an exemplary computing system in accordance with an example of the present disclosure.

FIG. 4Ai, FIG. 4Aii, FIG. 4Aiii, and FIG. 4Aiv illustrate an original view of a document displayed by a communication device.

FIG. 4B illustrates a reflow approach view of a document displayed by a communication device.

FIG. 5 illustrates a manually zoom in view of a document displayed by a communication device.

FIG. 6 illustrates a screen awareness approach view of a document displayed by a communication device in accordance with an exemplary embodiment.

FIG. 7 illustrates an example flowchart illustrating operations for providing screen-aware adjustment visualizations associated with displays in accordance with an example of the present disclosure.

FIG. 8 illustrates an example of a machine learning framework in accordance with one or more examples of the present disclosure.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

### Exemplary System Architecture

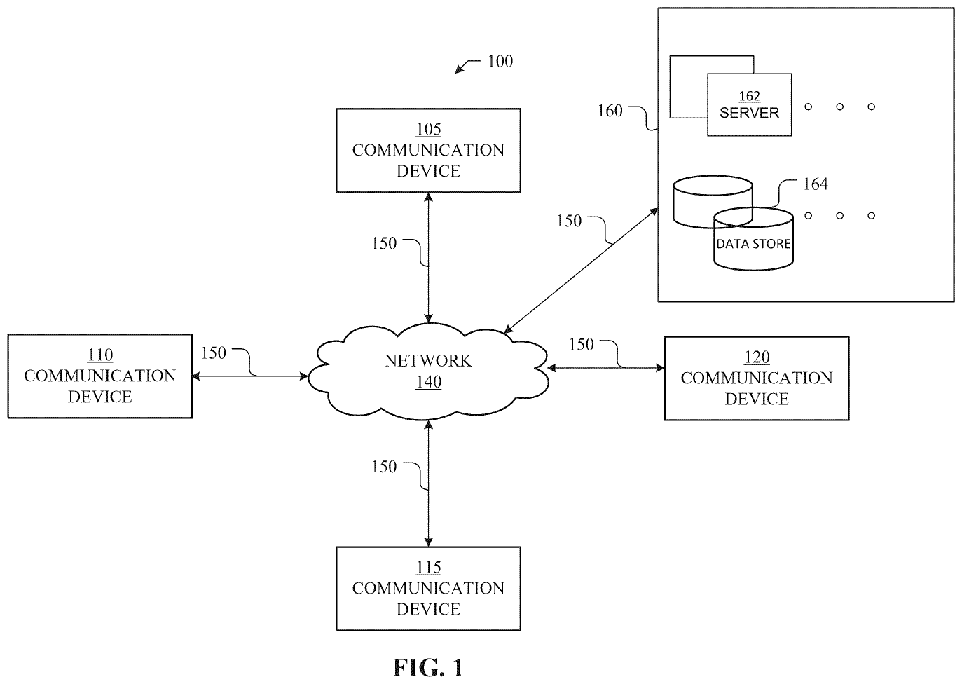

Reference is now made to FIG. 1, which is a block diagram of a system according to exemplary embodiments. As shown in FIG. 1, the system 100 may include one or more communication devices 105, 110, 115 and 120 and a network device 160. Additionally, the system 100 may include any suitable network such as, for example, network 140. In some examples, the network 140 may be a Metaverse network. In other examples, the network 140 may be any suitable network capable of provisioning content and/or facilitating communications among entities within, or associated with the network. As an example and not by way of limitation, one or more portions of network 140 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 140 may include one or more networks 140.

Links 150 may connect the communication devices 105, 110, 115 and 120 to network 140, network device 160 and/or to each other. This disclosure contemplates any suitable links 150. In some exemplary embodiments, one or more links 150 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In some exemplary embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout system 100. One or more first links 150 may differ in one or more respects from one or more second links 150.

In some exemplary embodiments, communication devices 105, 110, 115, 120 may be electronic devices including hardware, software, or embedded logic components or a combination of two or more such components and capable of carrying out the appropriate functionalities implemented or supported by the communication devices 105, 110, 115, 120. As an example, and not by way of limitation, the communication devices 105, 110, 115, 120 may be a computer system such as for example a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 105, 110, 115, 120 may enable one or more users to access network 140. The communication devices 105, 110, 115, 120 may enable a user(s) to communicate with other users at other communication devices 105, 110, 115, 120.

Network device 160 may be accessed by the other components of system 100 either directly or via network 140. As an example and not by way of limitation, communication devices 105, 110, 115, 120 may access network device 160 using a web browser or a native application associated with network device 160 (e.g., a mobile social-networking application, a messaging application, another suitable application, or any combination thereof) either directly or via network 140. In particular exemplary embodiments, network device 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 162 may include hardware, software, or embedded logic components or a combination of two or more such components for carrying out the appropriate functionalities implemented and/or supported by server 162. In particular exemplary embodiments, network device 160 may include one or more data stores 164. Data stores 164 may be used to store various types of information. In particular exemplary embodiments, the information stored in data stores 164 may be organized according to specific data structures. In particular exemplary embodiments, each data store 164 may be a relational, columnar, correlation, or other suitable database. Although this disclosure describes or illustrates particular types of databases, this disclosure contemplates any suitable types of databases. Particular exemplary embodiments may provide interfaces that enable communication devices 105, 110, 115, 120 and/or another system (e.g., a third-party system) to manage, retrieve, modify, add, or delete, the information stored in data store 164.

Network device 160 may provide users of the system 100 the ability to communicate and interact with other users. In particular exemplary embodiments, network device 160 may provide users with the ability to take actions on various types of items or objects, supported by network device 160. In particular exemplary embodiments, network device 160 may be capable of linking a variety of entities. As an example and not by way of limitation, network device 160 may enable users to interact with each other as well as receive content from other systems (e.g., third-party systems) or other entities, or to allow users to interact with these entities through an application programming interfaces (API) or other communication channels.

It should be pointed out that although FIG. 1 shows one network device 160 and four communication devices 105, 110, 115 and 120, any suitable number of network devices 160 and communication devices 105, 110, 115 and 120 may be part of the system of FIG. 1 without departing from the spirit and scope of the present disclosure.

### Exemplary Communication Device

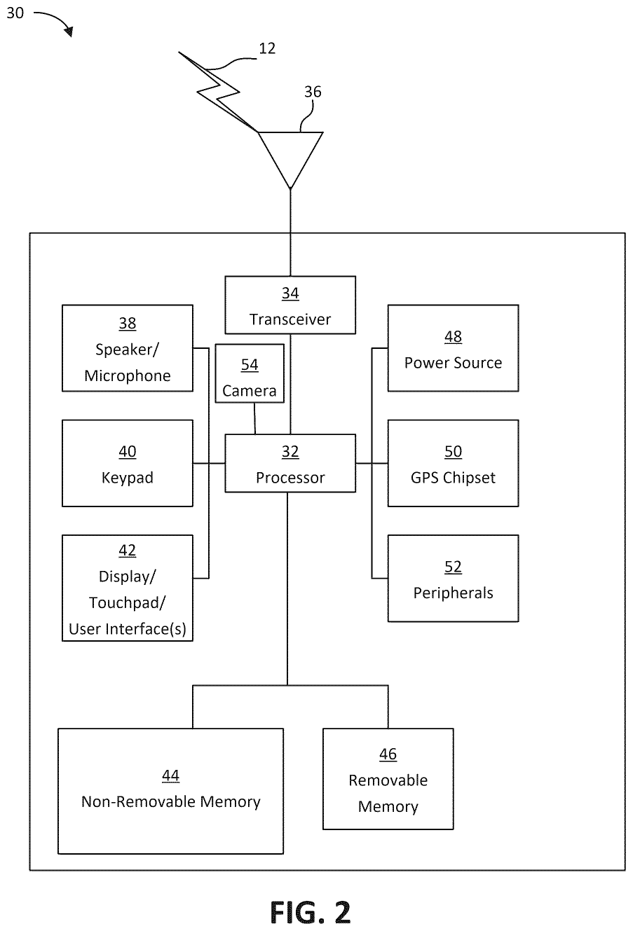

FIG. 2 illustrates a block diagram of an exemplary hardware/software architecture of a communication device such as, for example, user equipment (UE) 30. In some exemplary aspects, the UE 30 may be any of communication devices 105, 110, 115, 120. In some exemplary aspects, the UE 30 may be a computer system such as for example a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, smart watch, charging case, or any other suitable electronic device. As shown in FIG. 2, the UE 30 (also referred to herein as node 30) may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The power source 48 may be capable of receiving electric power for supplying electric power to the UE 30. For example, the power source 48 may include an alternating current to direct current (AC-to-DC) converter allowing the power source 48 to be connected/plugged to an AC electrical receptable and/or Universal Serial Bus (USB) port for receiving electric power. The UE 30 may also include a camera 54. In an exemplary embodiment, the camera 54 may be a smart camera configured to sense images/video appearing within one or more bounding boxes. The UE 30 may also include communication circuitry, such as a transceiver 34 and a transmit/receive element 36. It will be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., non-removable memory 44 and/or removable memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an exemplary embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another exemplary embodiment, the transmit/receive element 36 may be configured to transmit and/or receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, (e.g., non-removable memory 44 and/or removable memory 46) as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other exemplary embodiments, the processor 32 may access information from, and store data in, memory that is not physically located on the node 30, such as on a server or a home computer.

The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

### Exemplary Computing System

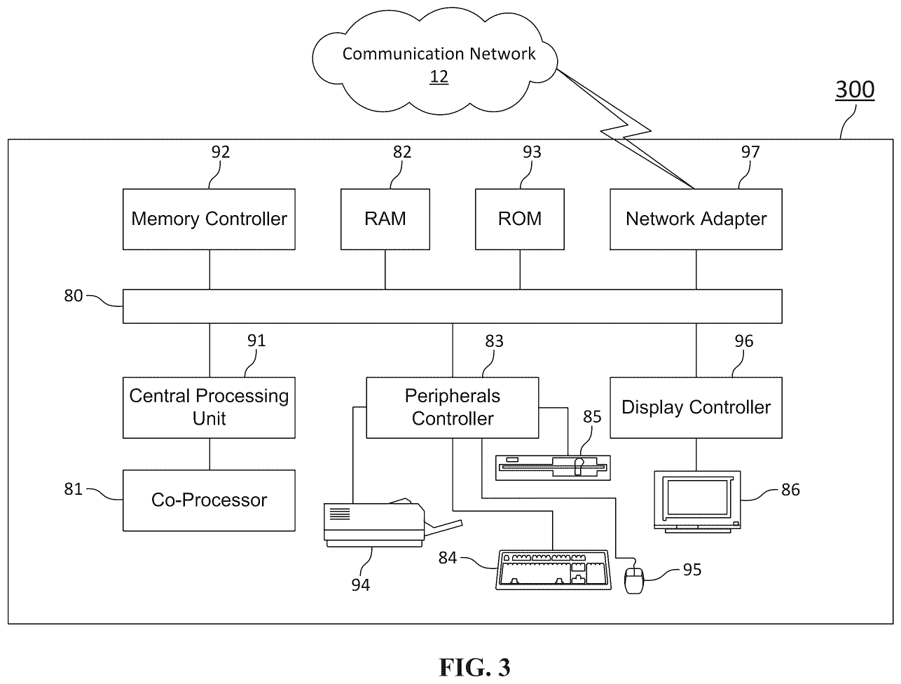

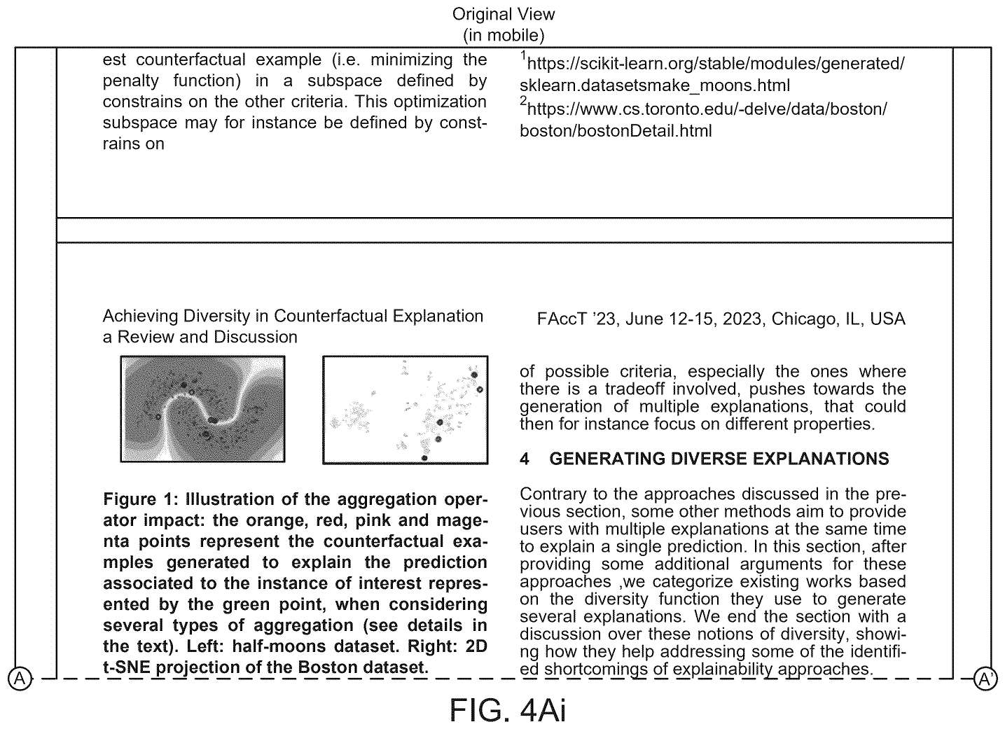

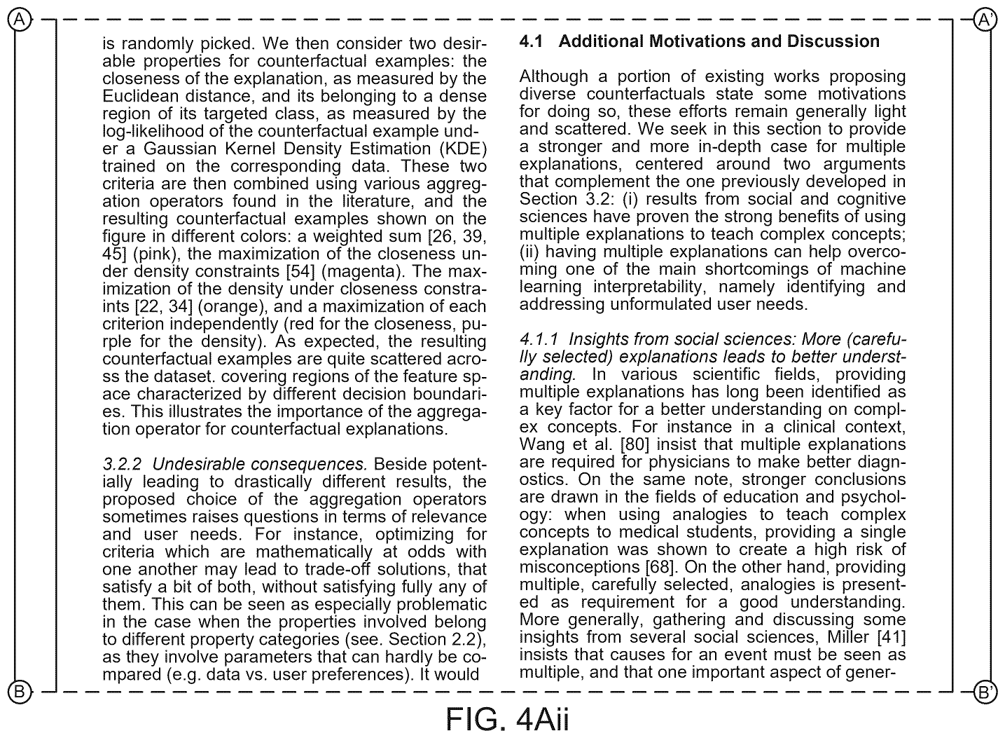

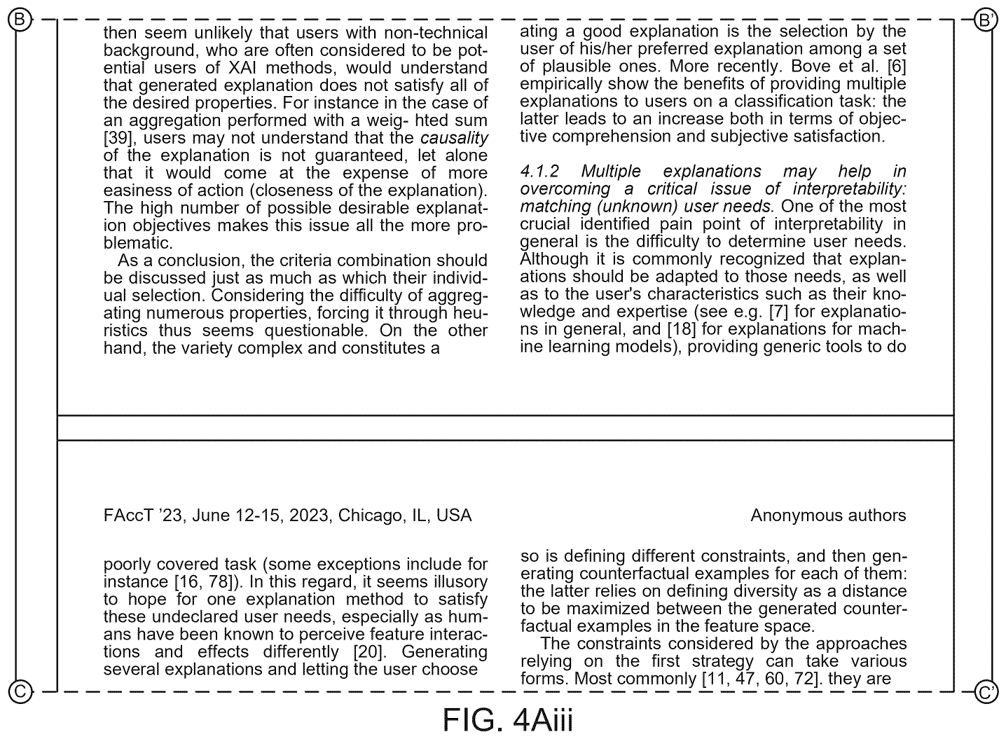

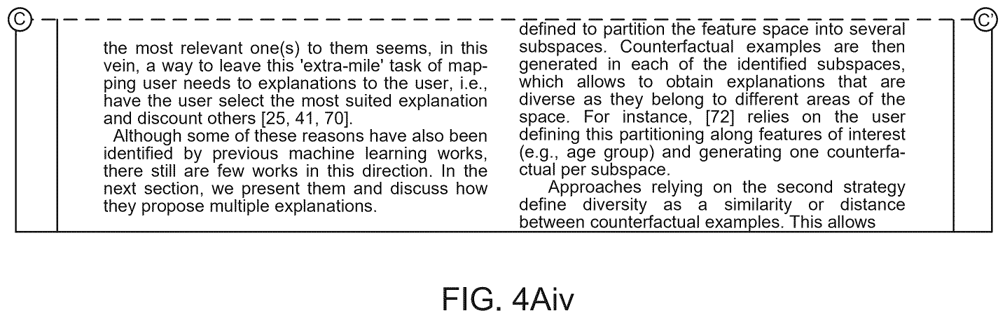

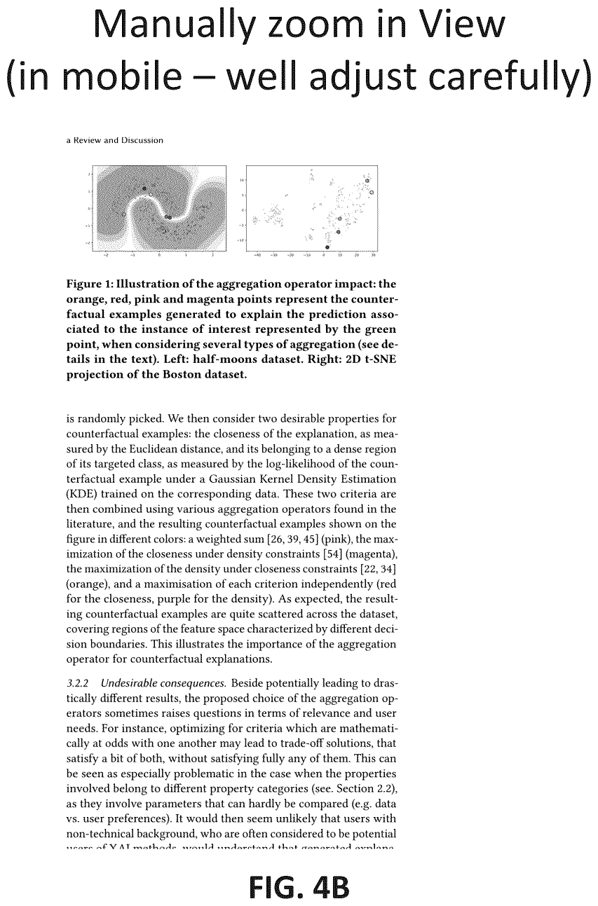

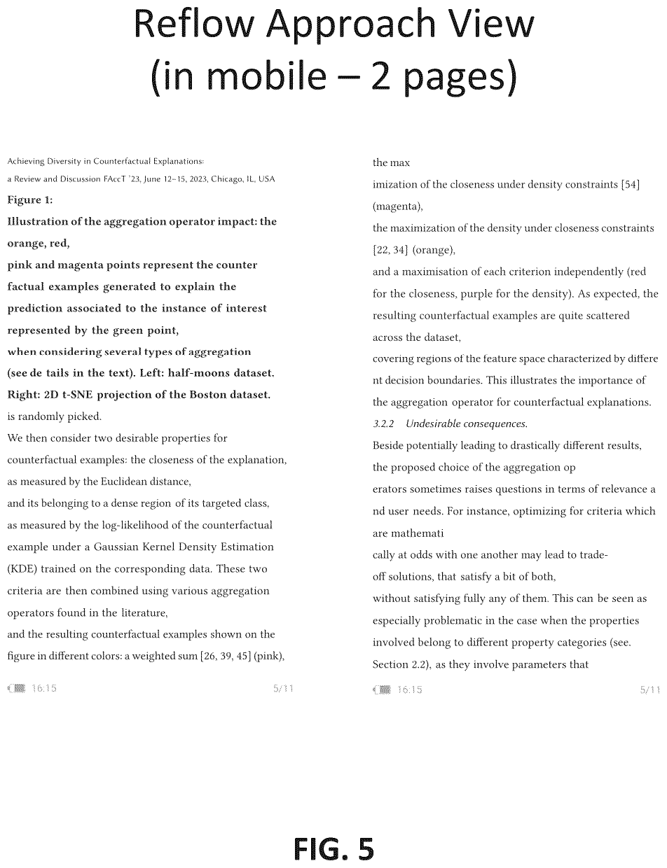

FIG. 3 is a block diagram of an exemplary computing system 300. In some example aspects of the present disclosure, the network device 160, and/or the network device 210 may be a computing system 300. The computing system 300 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 300 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 400 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 300 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 300. Such visual output may include text, graphics, animated graphics, and video. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 300 may contain communication circuitry, such as for example a network adaptor 97, that may be used to connect computing system 300 to an external communications network, such as network 12 of FIG. 2, to enable the computing system 300 to communicate with other nodes (e.g., UE 30) of the network.

### Exemplary System Operation

Some reasons why screen-awareness adjustment may be important may be due to PDF documents being widely used and spread, and social community/platforms also may have a lot of content shared in PDF format.

Smart phones/devices are pervasively used for work, study and entertainment, and the screen sizes may vary.

The examples of the present disclosure provide technical solutions and an innovation approach to resolve challenges associated with PDF in different sizes of screen devices.

It may be challenging to support different types of content, like charts, graphs etc., in a tooling solution such as the reflow approach via a certain algorithm(s), application(s) and/or machine learning model(s).

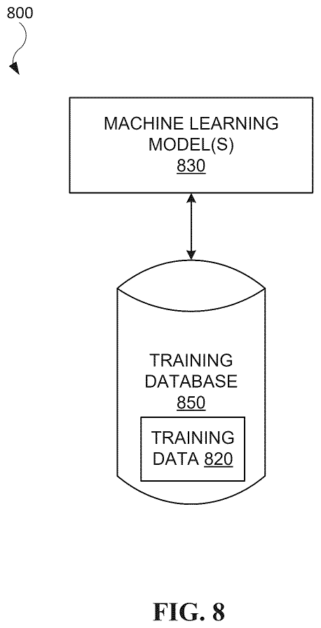

The examples of the present disclosure facilitate training a large language model-like generative model (LLM) (e.g., machine learning model(s) 830 of FIG. 8) to reconstruct (e.g., generate) the multiple types of content, which also may improve the text content extraction as well. In this manner, the examples of the present disclosure not only may extract and reconstruct all the content from a given PDF, but may also keep the semantic order of the content elements. Then these reconstructed content may be well organized into a well format fitted into a device screen size dynamically. (See e.g., FIG. 6).

Additionally, the examples of the present disclosure may also provide good support to displays in small screen devices, such as for example mobile phones and tablet computers etc., and also to large-screen displays, which may not be limited/constrained by the original PDF font size/wide/structure.

The model (e.g., the LLM) (e.g., machine learning model(s) 830 of FIG. 8) of the examples of the present disclosure may learn the layer out style from broader sources (e.g., web pages, newsletters, designer content, etc.) and then may apply the layout style to the PDF extracted element during the construction. The reconstruction may be able to apply the style related to the topic/category for the current PDF.

Additionally, by utilizing the generative approach, the model (e.g., the LLM) of the examples of the present disclosure may also auto-generate a summary or conclusion from the multimedia content (e.g., tables, graphs, charts, etc.) with the context around them, which may assist the reader/user to understand more information.

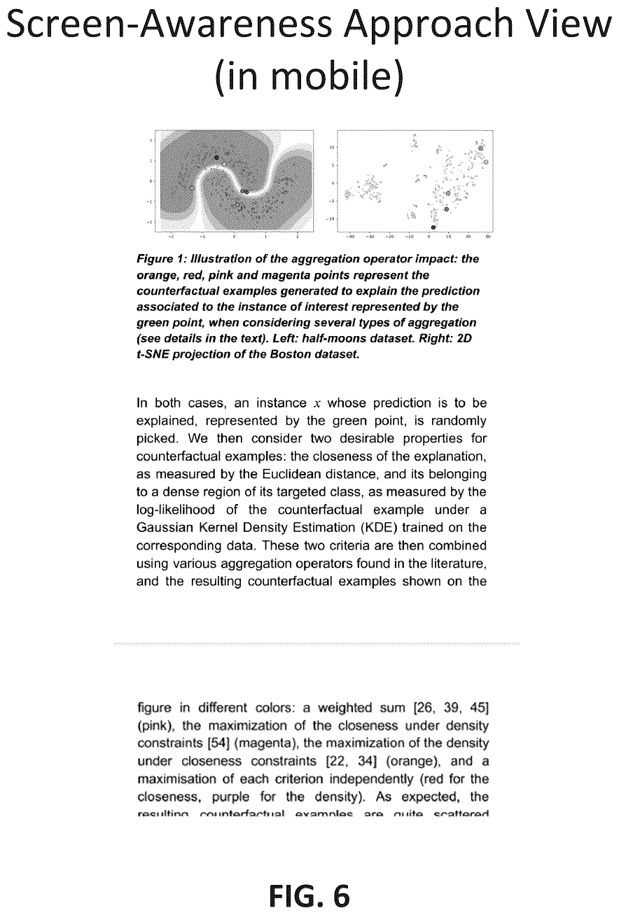

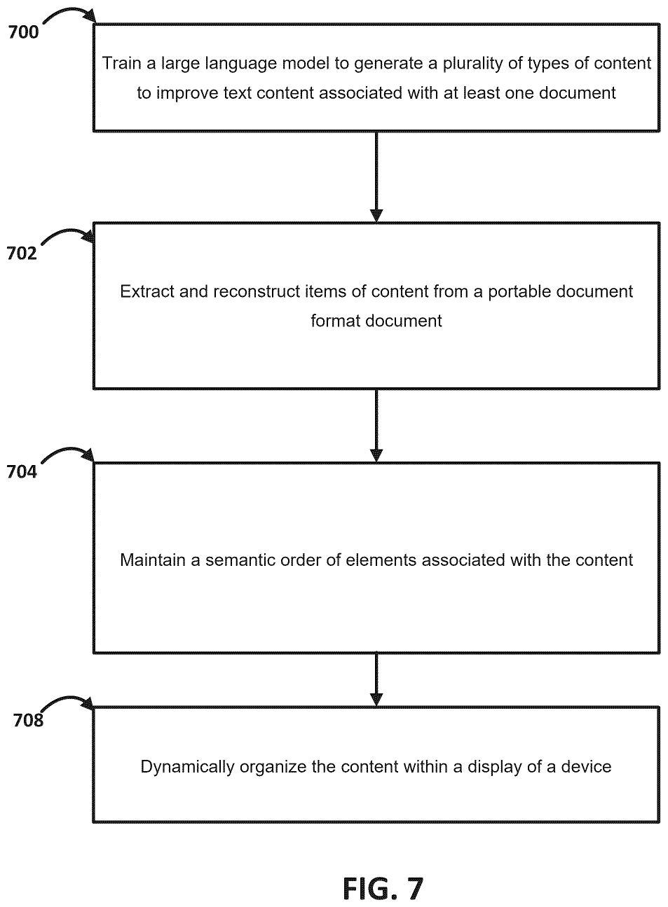

FIG. 7 illustrates an example flowchart illustrating operations for providing screen-aware adjustment visualizations associated with displays according to an example of the present disclosure. At operation 700, a device (e.g., computing system 300) may train a large language model (e.g., machine learning model(s) 830) to generate a plurality of types of content to improve text content associated with at least one document. At operation 702, a device (e.g., computing system 300) may extract and reconstruct items of content from a portable document format document.

At operation 704, a device (e.g., computing system 300) may maintain a semantic order of elements associated with the content. At operation 706, a device (e.g., computing system 300) may dynamically organize the content within a display of a device.

FIG. 8 illustrates an example of a machine learning framework 800 including machine learning model(s) 830 and a training database 850, in accordance with one or more examples of the present disclosure. The training database 850 may store training data 820. In some examples, the machine learning framework 800 may be hosted locally in a computing device or hosted remotely. By utilizing the training data 820 of the training database 850, the machine learning framework 800 may train the machine learning model(s) 830 to perform one or more functions, described herein, of the machine learning model(s) 830. In some examples, the machine learning model(s) 830 may be stored in a computing device. For example, the machine learning model(s) 830 may be embodied within a communication device (e.g., UE 30). In some other examples, the machine learning model(s) 830 may be embodied within another device (e.g., computing system 300). Additionally, the machine learning model(s) 830 may be processed by one or more processors (e.g., processor 32 of FIG. 2, coprocessor 81 of FIG. 3). In some examples, the machine learning model(s) 830 may be associated with operations (or performing operations) of FIG. 7. In some other examples, the machine learning model(s) 830 may be associated with other operations.

In an example, the training data 820 may include attributes of thousands of objects. For example, the objects may be posters, brochures, billboards, menus, goods (e.g., packaged goods), books, groceries, Quick Response (QR) codes, smart home devices, home and outdoor items, household objects (e.g., furniture, kitchen appliances, etc.) and any other suitable objects. In some other examples, the objects may be smart devices (e.g., UEs 30, communication devices 105, 110, 115, 120), persons (e.g., users), newspapers, articles, flyers, pamphlets, signs, cars, content items (e.g., messages, notifications, images, videos, audio), and/or the like. Attributes may include, but are not limited to, the size, shape, orientation, position/location of the object(s), etc. The training data 820 employed by the machine learning model(s) 830 may be fixed or updated periodically. Alternatively, the training data 820 may be updated in real-time based upon the evaluations performed by the machine learning model(s) 830 in a non-training mode. This may be illustrated by the double-sided arrow connecting the machine learning model(s) 830 and stored training data 820. Some other examples of the training data 820 may include, but are not limited to, data items (e.g., training data examples) associated with one or more functions, operations or the like of an application(s) associated with the machine learning model(s) 830.

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as components, without loss of generality. The described operations and their associated components may be embodied in software, firmware, hardware, or any combinations thereof.

Any of the steps, operations, or processes described herein may be performed or implemented with one or more hardware or software components, alone or in combination with other devices. In one embodiment, a software component is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method comprising:
training a large language model to generate a plurality of types of content to improve text content associated with at least one document;
extracting and reconstructing items of content from a portable document format (PDF) document, and maintaining a semantic order of elements associated with the content; and
organizing the content within a display of a device dynamically.
